(19) United States
(12) Patent Application Publication
(10) Pub. No.: US 2016/0173467 A1
(43) Pub. Date: Jun. 16, 2016

(54) DOCUMENT COLLABORATION THROUGH NETWORKING CREDENTIALS

(71) Applicant: Microsoft Technology Licensing, LLC, Redmond, WA (US)

(72) Inventor: Sumanth Pasupuleti, Bellevue, WA (US)

(21) Appl. No.: 14/571,209

(22) Filed: Dec. 15, 2014

(51) Int. Cl. H04L 29/06; G06F 17/24; H04L 29/08

(52) U.S. Cl. CPC H04L 63/08; H04L 65/403; H04L 67/02; H04L 67/10; G06F 17/241

(57) ABSTRACT

A productivity application may enable users to create, edit, and share content in a collaborative environment. Document collaboration through networking credentials may be facilitated by enabling a first user to select a second user to invite to view content of the productivity application through a control element of a productivity application user experience. An invitation may be sent to the second user to access the content, where the second user may be enabled to access the content within the productivity application by providing networking application credentials associated with the second user. Once the second user accesses the content, one or more other control elements may be provided through the productivity application user experience to enable the second user to provide feedback on the content. The feedback may then be saved in conjunction with the content such that the first user may review the feedback within the productivity application.

### BACKGROUND

Productivity applications, such as word-processing applications, spreadsheet applications, presentation applications, and notebook applications, among other examples, may enable users to create, edit, and share content. Increasingly, productivity applications may be executed in a collaborative environment, such that multiple users co-authoring a document or file, for example, may more efficiently edit and the share the updated content among one another. However, employing current implementations, the multiple users may only be able to access the content using credentials associated with a location where the content is stored. For example, if the content is stored within a web application, the users must provide their credentials associated with the web application to gain access to the content. If one or more of the users do not have access to the location, the content has to be sent individually to those users through one or more communication modes, and any feedback from those users may not be automatically stored with the content.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enablement of document collaboration through networking credentials that include providing a control element through a user experience of a productivity application to enable a first user to select a second user to invite to view content of the productivity application, sending an invitation to the second user to access the content, enabling the second user to access the content within the productivity application by providing networking application credentials associated with the second user, and providing one or more other control elements through the user experience of the productivity application to enable the second user to provide feedback on the content within the productivity application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where document collaboration may be enabled through networking credentials;

FIG. 2 illustrates another example network environment where document collaboration may be enabled through networking credentials;

FIGS. 3A and 3B illustrate an example user experience of a productivity application that may enable a first user to select a second user to invite to view content of the productivity application;

FIGS. 4A-4D illustrate an example user experience of a networking application that may notify and prompt an invited user to access content of a productivity application;

FIGS. 5A and 5B illustrate another example user experience of a productivity application that may enable a user to review feedback provided by one or more invited users;

FIG. 6 illustrates an example system configured to enable document collaboration through networking credentials;

FIG. 7 is a block diagram of an example general purpose computing device, which may be used to enable document collaboration through networking credentials; and

FIG. 8 illustrates a logic flow diagram of a method to enable document collaboration through networking credentials, according to embodiments.

### DETAILED DESCRIPTION

As briefly described above, a productivity application that enables users to create, edit, and share content, such as documents and files, may be executed in a collaborative environment such that multiple users viewing and/or editing the content may more efficiently share a most recent version of the content among one another. Document collaboration through networking credentials may be employed to further increase user efficiency. For example, a control element may be provided through a user experience of the productivity application to enable a first user to select a second user to invite to view content of the productivity application. An invitation may be sent to the second user to access the content, where the second user may be enabled to access the content within the productivity application by providing networking application credentials associated with the second user. Once the second user accesses the content within the productivity application, one or more other control elements may be provided through the user experience of the productivity application to enable the second user to provide feedback on the content within the productivity application.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for enablement of document collaboration through networking credentials. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

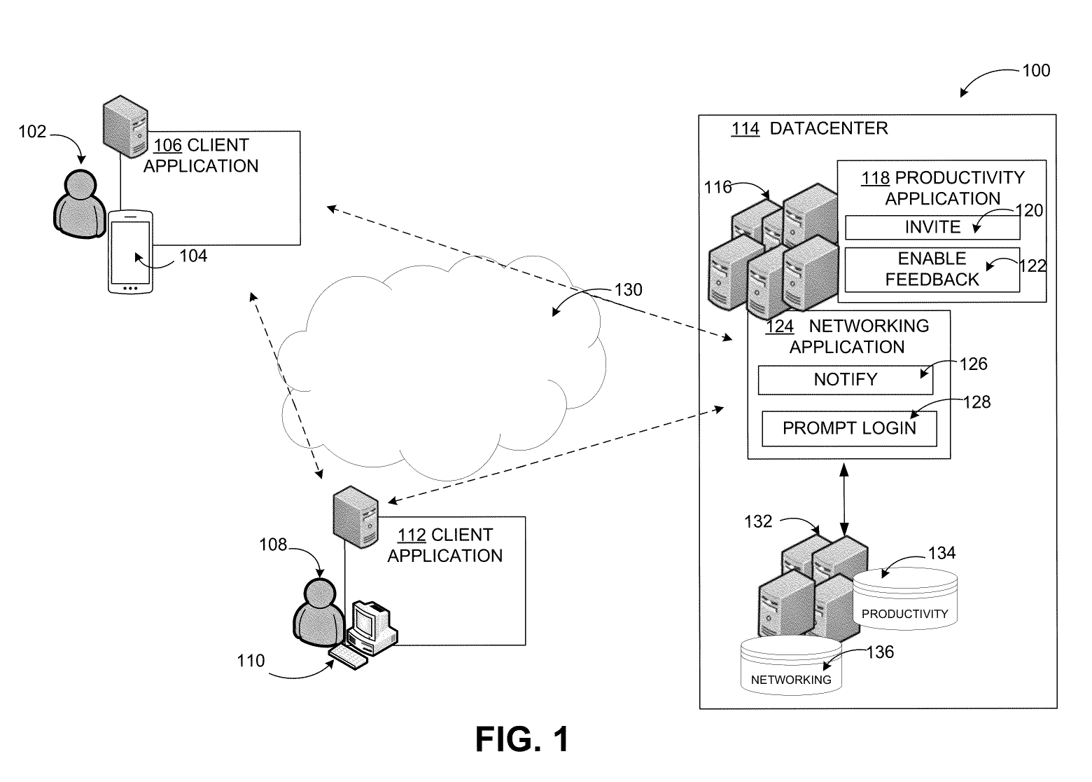

FIG. 1 includes an example network environment where document collaboration may be enabled through networking credentials. As shown in diagram 100, a datacenter 114, may include one or more processing servers 116, where at least one of the processing servers 116 may be configured to execute a productivity application 118, and at least another one of the processing servers 116 may be configured to execute a networking application 124. In other examples, the productivity application 118 and/or the networking application 124 may be provided by a third party service or may be web applications. The productivity application 118 may be a word-processing application, a presentation application, a spreadsheet application, or a notebook application, among other examples, that enables users, such as a first user 102 and a second user 108 to create, edit, and share content. The content may include structured data or streaming data associated with audio, video, graphics, images, and/or text. The networking application 124 may include a social networking application or a professional networking application, for example, that enables users to create a profile with biographical data, photos and any other information, such that the users may share their activities with family, friends and colleagues or share interest in a particular topic. The datacenter 114 may also include one or more storage servers 132 configured to manage one or more data stores 134, 136 comprising data associated with the productivity application 118 and the networking application 124, respectively.

Access to the productivity application 118 and/or the networking application 124 may be provided through one or more client applications 106, 112 executed on client devices 104, 110 associated with the first user 102 and the second user 108, respectively. The client devices 104, 110 may include a desktop computer, a laptop, a tablet, a smart phone, and a wearable, among other similar computing devices, for example. The first user 102 and the second user 108 may be enabled to share content with one another over a network such as a cloud 130.

In an example embodiment, the datacenter 114 may provide the first user 102 access to the productivity application 118 through the client application 106. The productivity application 118 may be configured to enable the first user 102 to invite 120 the second user 108 to view the content of the productivity application 118. For example, the productivity application 118 may be configured to provide a control element through a user experience of the productivity application 118 to enable the first user 102 to select the second user 108 to invite to view content of the productivity application 118. In some embodiments, a list of potential users for selection may be provided to the first user 102 through the user experience upon actuation of the control element such that the first user 102 is enabled to select the second user 108 efficiently. The provided list may be based on determined context of the content. For example, one or more unlikely users to invite may be removed based on the determined context, and the remaining users to invite may be prioritized based on the determined context and presented in the list. The determined context of the content may include a type of the content, phrases within the content, a reference to intranet sites, geotags, and a reference to other users, among other examples. In other embodiments, upon actuation of the control element, the datacenter 114 may provide the first user 102 access to the networking application 124 through the client application 106 such that the first user 102 may select the second user 108 from a list of users provided through a user experience of the networking application 124 associated with the first user 102.

The productivity application 118 may be configured to send an invitation to the second user 108 to access the content, where the invitation may be sent to the second user through the networking application 124. The datacenter 114 may provide the second user 108 access to the networking application 124 through the client application 112, where upon receipt of the invitation, a user experience of the networking application 124 associated with the second user 108 may be configured to notify 126 the second user 108 of the invitation. In some examples, the invitation may include a link to a location of the content. Upon actuation of the link by the second user 108, the networking application may prompt 128 the second user 108 to login to the productivity application 118. The second user 108 may be enabled to access the content within the productivity application 118 by providing the networking application credentials associated with the second user 108. In response to the login, the datacenter 114 may provide the second user 108 access to the productivity application 118 through the client application 112.

The productivity application 118 may then enable the second user 108 to provide feedback 122 on the content. For example, the productivity application 118 may be configured to provide one or more other controls through the user experience of the productivity application 118 (and/or client application 112 associated with the second user 108) that enable the second user 108 to provide feedback on the content. The feedback may include comments and/or likes. Additionally, if multiple users were invited to provide feedback on the content by the first user 102, the second user 108 may be enabled to view comments provided by the other invited users. In some embodiments, feedback permissions may be assigned through the networking application credentials associated with the second user 108, where the feedback permissions may be based on one or both of the second user 108 and the networking application. The feedback permissions may directly indicate a type of feedback the second user 108 may provide. The feedback permissions may also indirectly indicate a level of collaborative influence the second user 108 may have. For example, for work-related content, colleagues associated with professional networking applications may have more collaborative influence on the content than friends associated with social networking applications. Accordingly, the colleagues may have unlimited feedback permissions associated with their professional networking application credentials. The feedback may be saved in conjunction with the content at the data store 134 associated with the productivity application 118 such that the first user 102 may be enabled to view the feedback through the user experience of the productivity application 118 (and/or client application 106 associated with the first user 102), which may be provided to the first user 102 through the client application 106.

A textual scheme, a graphical scheme, an audio, scheme, an animation scheme, a coloring scheme, a highlighting scheme, and/or a shading scheme to enhance presentation of the feedback in the user experience. For example, a first icon indicating a type of feedback, such as a comment or like, a second icon indicating the networking application 124 associated with the second user 108, and a name of the second user 108 may be displayed to represent a comment and/or a like from the second user 108. In some examples, multiple users may provide feedback on the content, where the users may be associated with different networking applications. In such examples, the presentation of the feedback may be distinct for each user and each networking application. For example, different colors of icons may be used to distinguish between social networking applications and networking applications, and different symbols may be used to distinguish between each of the social networking applications and each of the networking applications.

In further embodiments, the first user 102, may be enabled to hover over a comment and/or like provided by the second user 108 to cause further information associated with the second user 108 to be displayed through the user experience, where the information may be collected by the networking application 124. For example, if the networking application 124 is a professional networking application, the information may include a photograph, a name, and a location of the second user 108, as well as a job title, an associated company, and work-related experience of the second user 108.

As previously discussed, multiple users co-authoring content through a productivity application in a collaborative environment may only be able to access the content using their credentials associated with a location where the content is stored, employing current implementations. For example, if the content is stored within a web application, the users must provide their credentials associated with the web application to gain access to the content. If one or more of the users do not have access to the location, the content has to be sent individually to those users through one or more communication modes, and any feedback from those users may not be automatically stored with the content. Document collaboration through networking credentials, as described in the embodiments herein, may enable users to access content of a productivity application through networking application credentials associated with the users. The content may be provided to multiple users through a single application, and content feedback may be enabled such that the feedback may be saved in conjunction with the content within the productivity application. Accordingly, enabling access to the content through the networking credentials may increase user efficiency, which may further promote collaboration among multiple users.

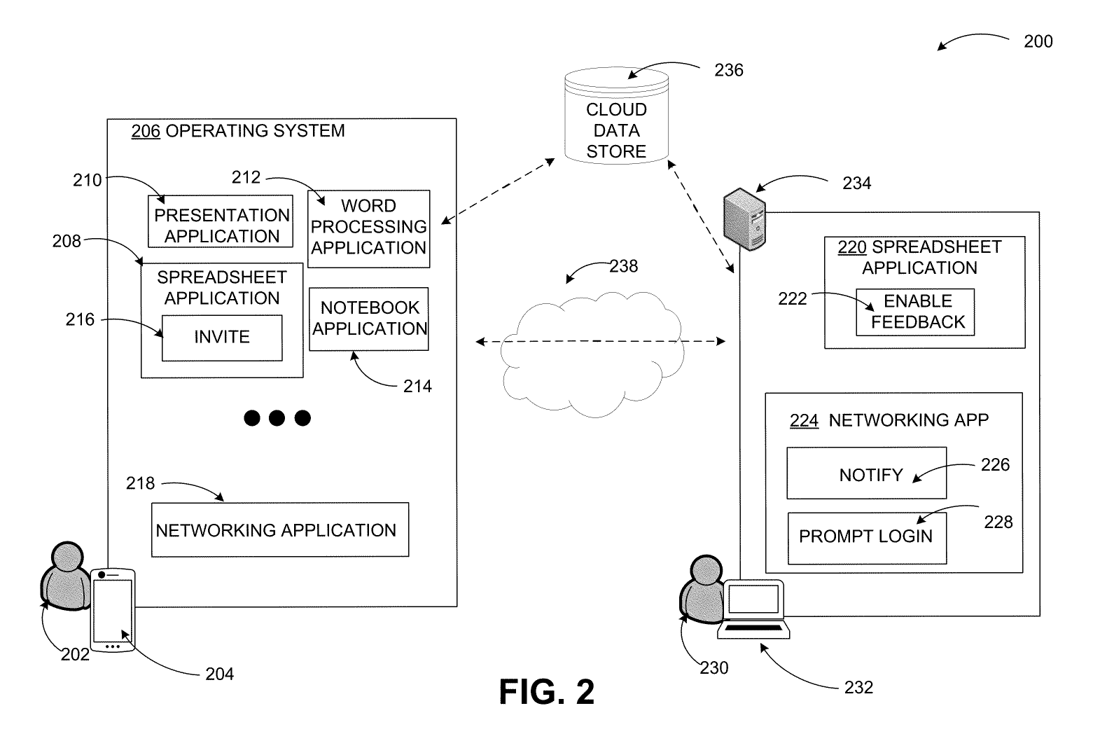

FIG. 2 illustrates another example network environment where document collaboration may be enabled through networking credentials. An operating system may be configured to manage hardware and software components of a computing device, and provide common services and applications. As shown in a diagram 200, an operating system 206 of a first computing device 204, such as a smart phone, associated with a first user 202 may be configured to provide the first user 202 access to one or more productivity applications. The one or more productivity applications may include a communication application, a word-processing application 212, a spreadsheet application 208, a notebook application 214, or a presentation application 210 that upon execution may enable the first user 202 to communicate, create, edit, and share content with other users, such as a second user 230, over a network such as a cloud 238. In some examples, the content of the productivity applications may be stored in a cloud data store 236, as illustrated, or in a data store associated with the first computing device 204. The operating system 206 may be further configured to provide the first user 202 access to a networking application 224, which may be a social networking application or a professional networking application, for example. The second user 230 with whom the first user 202 shares content with over the cloud 238, may be associated with a second computing device 232, such as a laptop. A processor 234 (or multiple processors) of the second computing device 232 may be configured to execute, among other things, a spreadsheet application 220 and a networking application 224 associated with the second user 230, for example.

In an example embodiment, the first user 202 may create and save content to the cloud data store 236 through the spreadsheet application 208. The first user 202 may want to share the content with one or more other users, such as the second user 230 to receive feedback on the content. The spreadsheet application 208 may be configured to enable the first user 202 to invite 216 the second user 230 to view the content of the spreadsheet application 208. For example, the spreadsheet application 208 may be configured to provide a control element through a user experience of the spreadsheet application 208 to enable the first user 202 to select the second user 230 to invite to view content of the spreadsheet application 208. In some embodiments, a list of potential users for selection may be provided to the first user 202 through the user experience of the spreadsheet application 208 in response to the actuation of the control element by the first user 202,. In other examples, the networking application 218 associated with the first user 202 may be invoked in response to the actuation of the control element by the first user 202. The first user 202 may then select the second user 230 to invite to view content of the spreadsheet application 208 through a user experience of the networking application 224.

Upon selection of the second user 230, the spreadsheet application 208 may be configured to send an invitation to the second user 230 to access the content. The invitation may be sent to the second user 230 through the networking application 224 associated with the second user 230, where the networking application 224 may be a same networking application as the networking application 218 associated with the first user 202. Upon receipt of the invitation, the networking application 224 may be configured to notify 226 the second user 230 of the invitation. In some examples, the invitation may include a link to a location of the content. For example, the invitation may include a link to the location of the content within the cloud data store 236. Upon actuation of the link by the second user 230, the networking application 224 may prompt 228 the second user 230 to login to the spreadsheet application 220 using networking application credentials associated with the second user 230. The second user 230 may be enabled to access the content stored in the cloud data store 236 through the spreadsheet application 220 by providing the networking application credentials associated with the second user 230. In response to the login, the second user 230 may receive the content from the cloud data store 236 through the spreadsheet application 220.

The spreadsheet application 220 may then enable the second user 230 to provide feedback 222 on the content. For example, the spreadsheet application 220 may be configured to provide one or more other controls through the user experience of the spreadsheet application 220 that enable the second user 230 to provide feedback on the content. The feedback may include comments and/or likes. In some embodiments, feedback permissions may be assigned through the networking application credentials associated with the second user 230, where the feedback permissions may be based on one or both of the second user 230 and the networking application 224 associated with the second user 230. The feedback may be saved in conjunction with the content at the cloud data store 236 such that the first user 202 may be enabled to view the feedback, which may be presented to the first user 202 through the user experience of the spreadsheet application 208.

A textual scheme, a graphical scheme, an audio, scheme, an animation scheme, a coloring scheme, a highlighting scheme, and/or a shading scheme may be employed to enhance presentation of the feedback in the user experience. In some examples, multiple users may provide feedback on the content, where the users may be associated with different networking applications. In such examples, the presentation of the feedback may be distinct for each user and each networking application. In further embodiments, the first user 202, may be enabled to hover over a comment and/or like left by the second user 230 to cause further information associated with the second user 230 to be displayed through the user experience, where the information is collected by the networking application 224. For example, if the networking application 224 is a social networking application, the information may include a photograph, a name, and a location of the second user 230, as well as a job title, an associated company, past education, and relationship status of the second user 230.

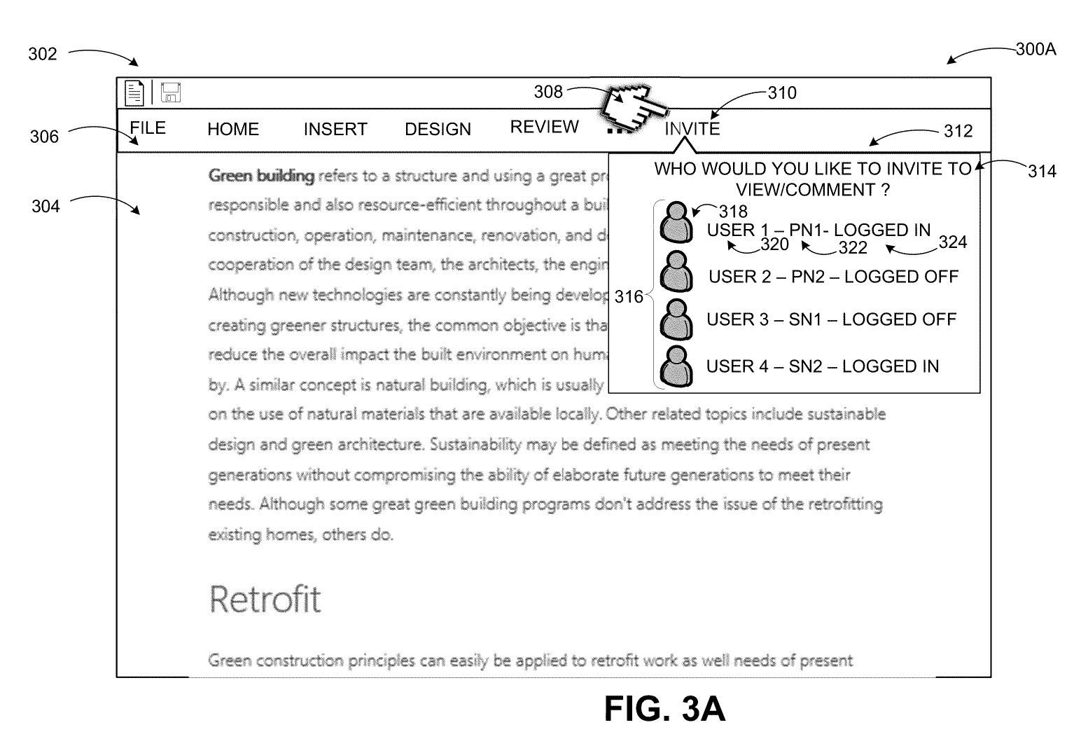

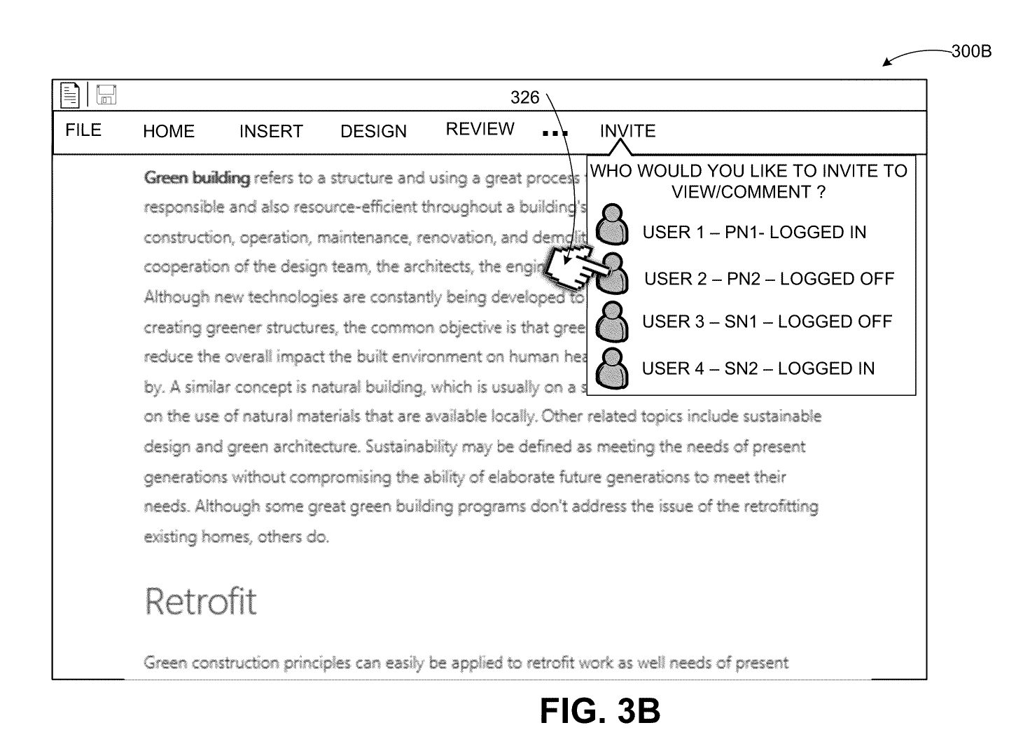

FIGS. 3A and 3B illustrate an example user experience of a productivity application that may enable a first user to select a second user to invite to view content of the productivity application. As shown in FIG. 3A, diagram 300A, a productivity application, such as a word-processing application 302, may enable a first user to communicate, create, edit, and share content 304 with other users. A user experience of the word-processing application 302 may include a tool bar 306 comprising one or more control elements to enable the first user to interact with the word-processing application 302 to communicate, create, edit, and share the content 304 with the other users. For example, the first user may select and/or hover over an “invite” control element 310 through a first user action 308 to invite a second user to view the content 304. The first user action 308 may include a touch input, gesture input, voice command, eye tracking, gyroscopic input, pen input, mouse input, and/or keyboard input, among other examples.

In response to the first user action 308, a display element 312 may be presented to the first user through the user experience of the word-processing application 302, where the display element 312 may be a drop-down menu, a pop-up menu, and/or a dialog box, among other examples. The display element 312 may include a prompt 314 for the first user to select a second user to invite to view the content 304, and a list of potential users 316 for selection. As illustrated, a photograph 318, a name 320, an associated networking application 322, and an availability status 324 of each user may additionally be presented. For example, user 1 may be associated with and currently logged into professional networking application 1.

In some embodiments, the list of potential users 316 for selection provided to the first user may be based on determined context of the content 304 to enable the first user to more efficiently select the second user. For example, one or more unlikely users to invite may be removed based on the determined context, and the remaining users to invite may be prioritized based on the determined context and presented in the list. The determined context of the content 304 may include a type of the content 304, phrases within the content 304, a reference to intranet sites, geotags, and a reference to other users, and other similar contextual information. For example, if the content 304 includes a reference to an intranet site associated with a company, and a reference to one or more colleagues associated with the company, friends and family may be removed from the list and colleagues may be prioritized within the list based on other contextual elements. As shown in FIG. 3B, diagram 300B, the first user may select and/or hover over the second user, such as User 2, through a second user action 326 to invite the second user to view the content 304. The second user action 326 may include a touch input, gesture input, voice command, eye tracking, gyroscopic input, pen input, mouse input, and/or keyboard input, among other examples.

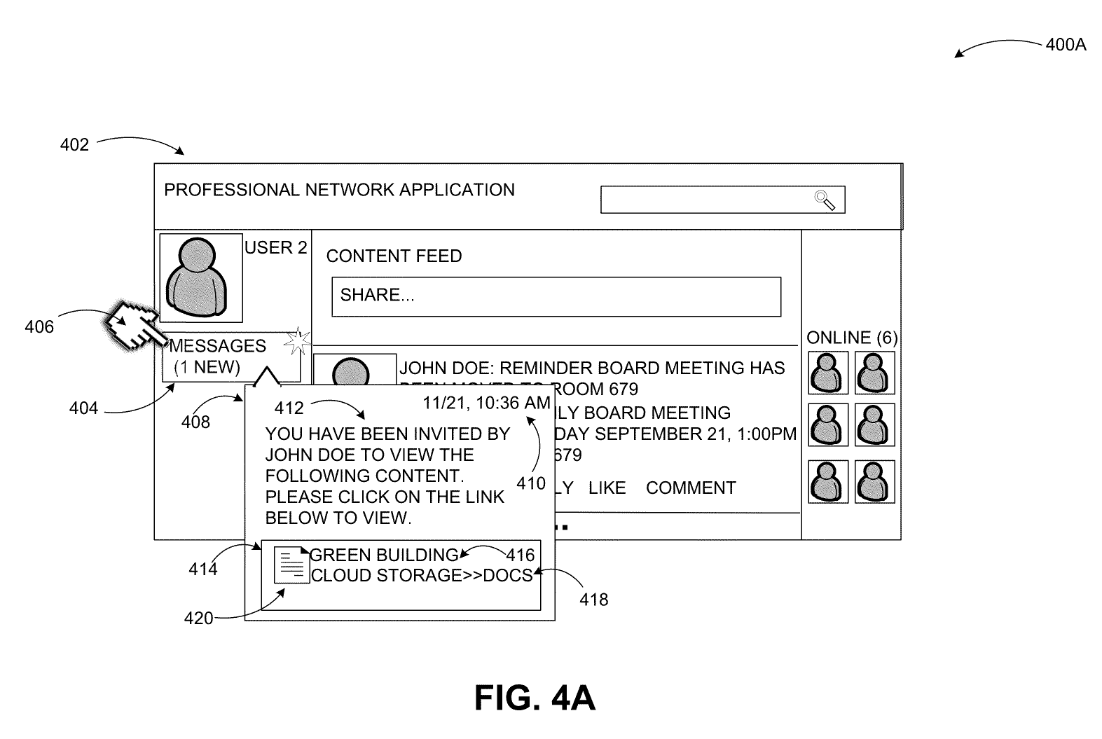

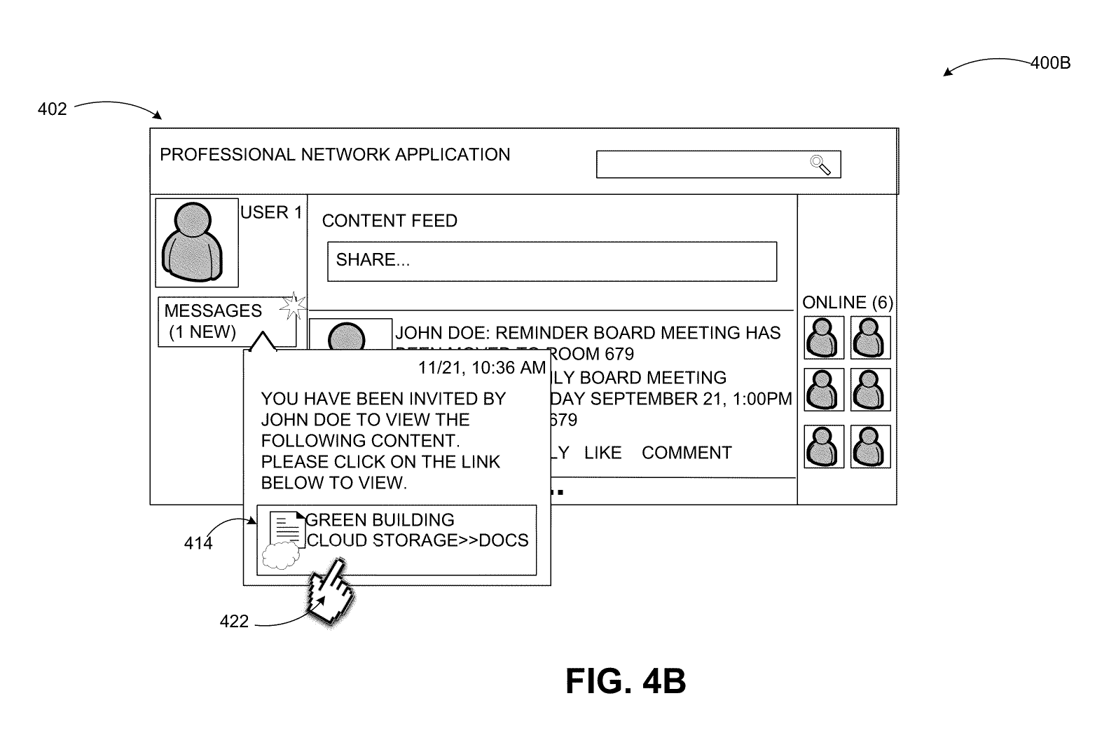

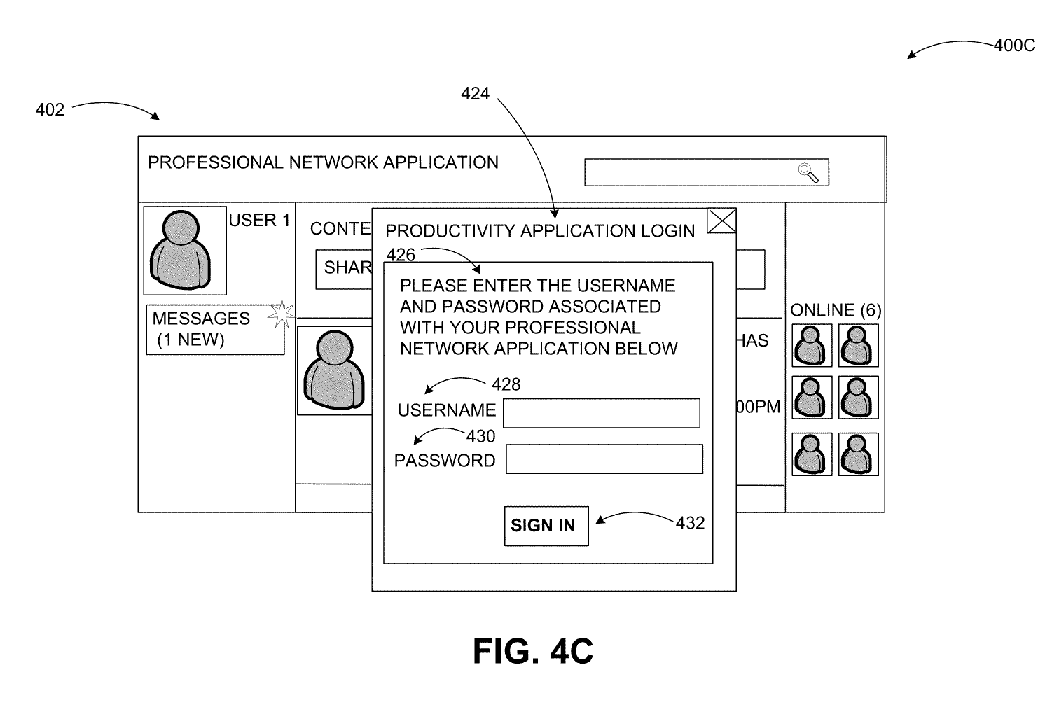

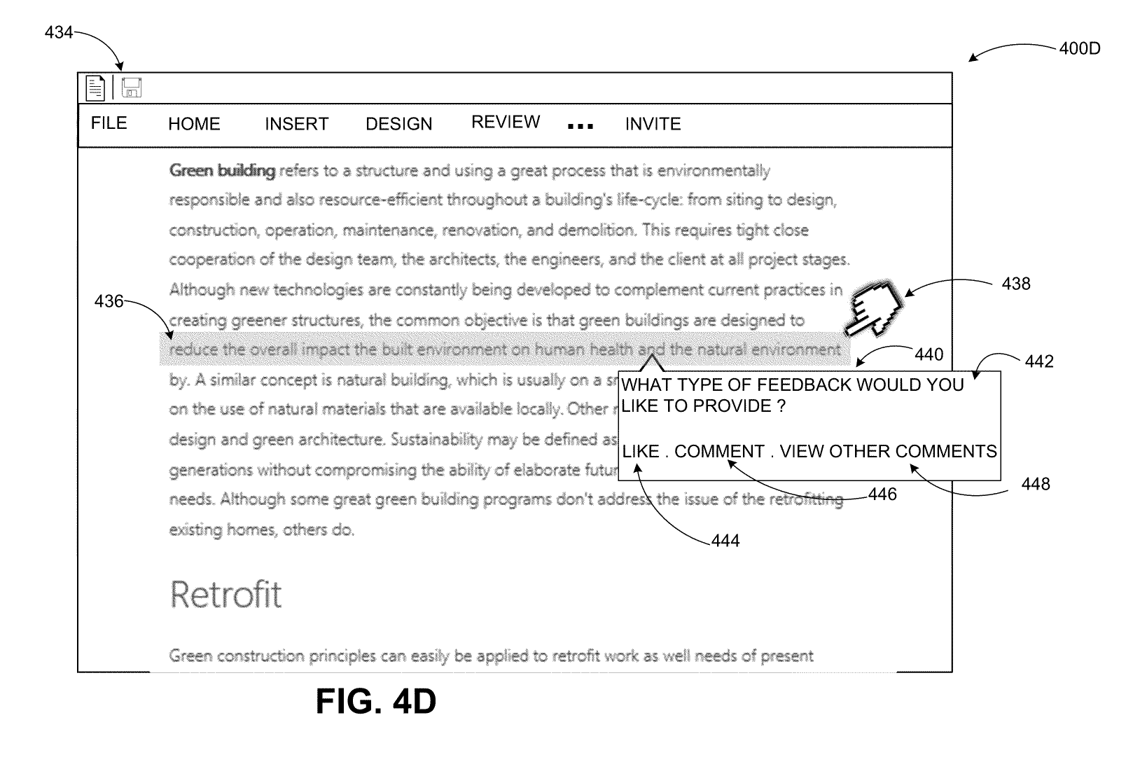

FIGS. 4A-4D illustrate an example user experience of a networking application that may notify and prompt an invited user to access content of a productivity application. As shown in FIG. 4A, diagram 400A, a networking application 402 may be associated with a second user invited by a first user to view content of a productivity application. The networking application 402 may be a professional networking application, for example. The networking application 402 may provide a notification 404 to the second user that an invitation has been received. As illustrated, the notification 404 may include a textual and graphical scheme.

In response to the second user selecting and/or hovering over the notification 404 through a first user action 406, the networking application 402 may present a display element 408 to the second user, where the display element 408 may be a drop-down menu, a pop-up menu, or a dialog box, among other examples. The display element 408 may include a date and time 410 the invitation was received, a prompt 412 that informs the second user of who sent the invitation and how to access the content, and a link 414 to a location of the content. The link may include a name 416 of the content, a location 418 of the content, and an icon 420 that represents a type of the content, such as a word-processing document, as illustrated. As shown in FIG. 4B, diagram 400B, the second user may be enabled to actuate the link 414 to the location of the content through a second user action 422.

As shown in FIG. 4C, diagram 400C, in response to actuation of the link, the networking application 402 may be configured to prompt the second user to login to a productivity application using networking application credentials associated with the second user. For example, the networking application 402 may present a “productivity application login” 424 to the second user. The “productivity application login” 424 may include a prompt 426 that provides instructions to the second user to enter networking credentials associated with the user, such as a user name 428 and a password 430, into wells below. Once the second user enters the user name 428 and password 430 into the wells, the second user may actuate the “sign in” 432 control element to log in to a productivity application 434, as shown in FIG. 4D, diagram 400D.

One or more control elements may be provided through a user experience of the productivity application 434 to enable the second user to provide feedback on content within the productivity application 434. For example, in response to the second user highlighting a portion of the content 436 through a user action 438, a display element 440 may be presented to the user through the user experience of the productivity application 434. The display element 440 may include a prompt 442 asking the second user to select what type of feedback the second user would like to provide. The type of feedback may include a like 444 or a comment 446, for example. In other embodiments, if multiple users were invited to provide feedback on the content by the first user, an option to view other comments 448 may be provided to the second user in the display element.

In further examples, feedback permissions may be assigned to the second user through their networking application credentials, where the permissions may be based on the second user and/or or the networking application. The permissions may limit what type of feedback the second user may choose to provide. For example, if the second user is associated with a social networking application, the second user may only be enabled to like the content. However, if the second user is associated with a professional networking application, the second user may be enabled to like and comment on the content.

Once the second user selects a type of feedback to provide, the second user may like and/or comment on the content. The feedback may then be saved in conjunction with the content in a data store associated with the productivity application 434 such that the first user may be enabled to view the feedback.

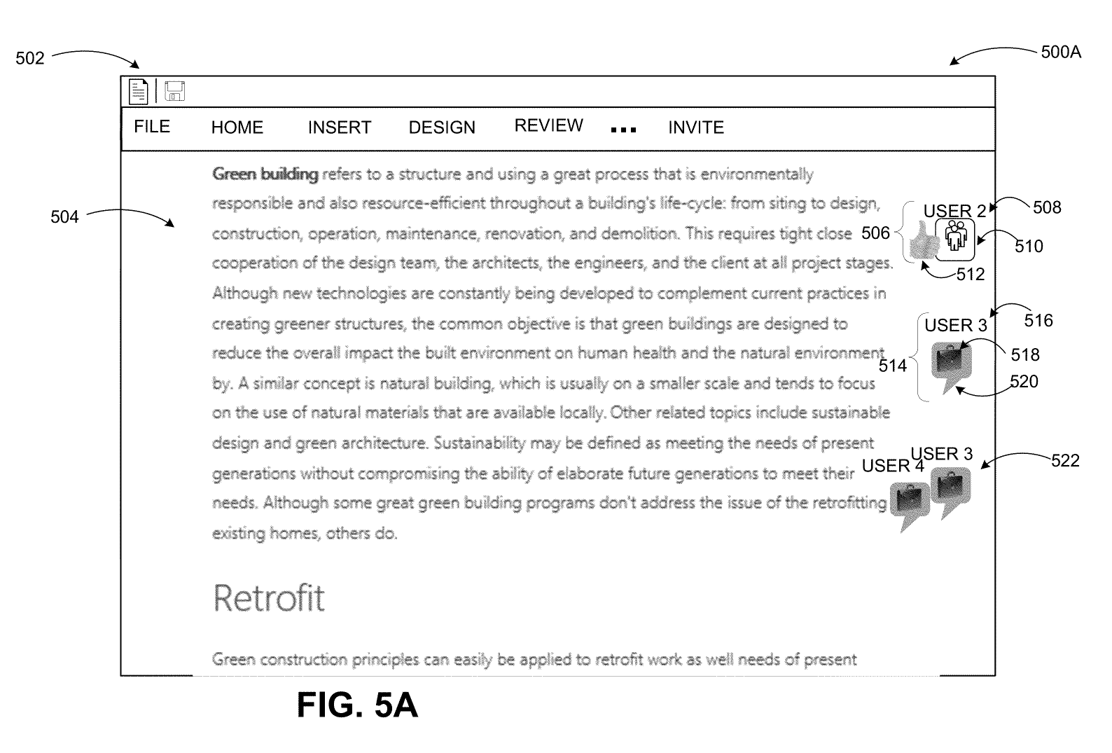

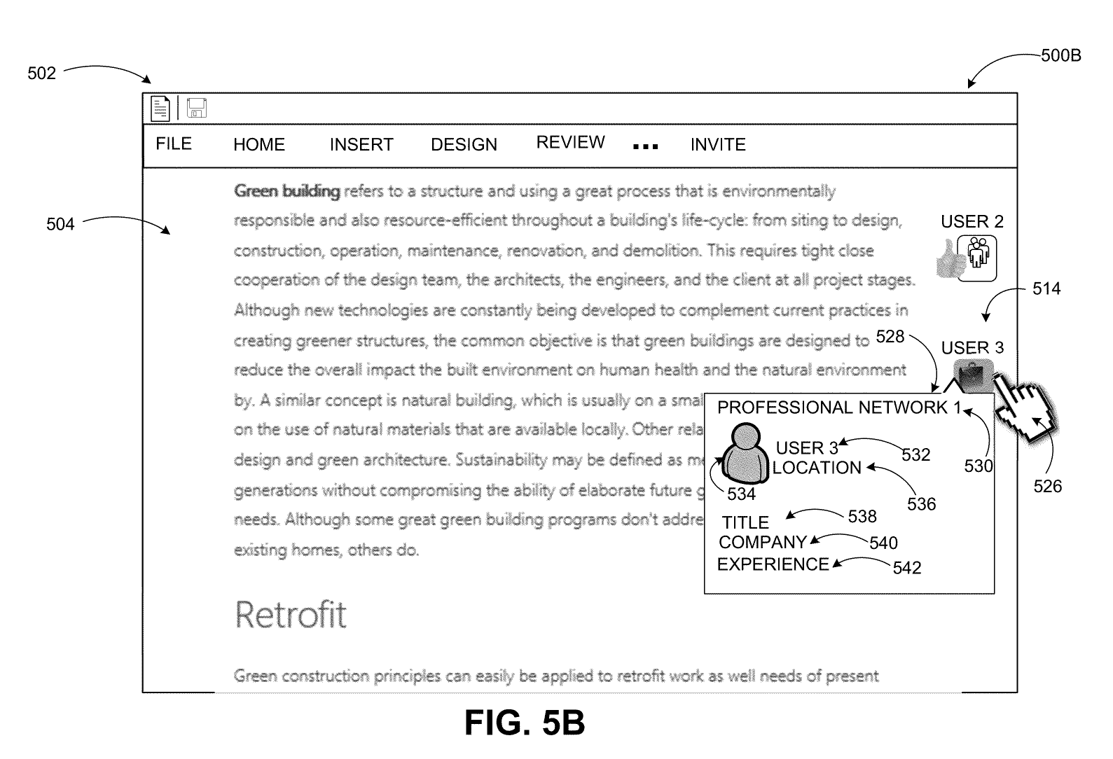

FIGS. 5A and 5B illustrate another example user experience of a productivity application that may enable a user to review feedback provided by one or more invited users. As shown in FIG. 5A, diagram 500A, a productivity application, such as a word-processing application 502, may present a first user with feedback on content 504 provided by multiple users associated with different networking applications. The feedback may be presented through a user experience of the word-processing application 502, and the feedback may include one or more comments (e.g., 514, 522) and likes (e.g., 506) on the content 504, for example.

The word-processing application 502 may enhance a presentation of the feedback through the user experience by employing a textual scheme, a graphical scheme, an audio scheme, an animation scheme, a coloring scheme, a highlighting scheme, and/or a shading scheme. Furthermore, when multiple users have provided feedback the feedback associated with each user and/or networking application may be presented distinctly, as illustrated, to enable the first user to easily distinguish who provided the feedback. For example, the feedback may be presented such that a name of the user, a type of feedback, and a social networking application associated with the user is indicated. As illustrated, a like 506 provided by “User 2” associated with a social networking application may be presented using a textual scheme to provide a name 508, and graphical schemes, such as a like icon 512 to indicate the type of feedback and a social icon 510 to represent the social networking application associated with “User 2”. Similarly, a comment 514 provided by “User 3” associated with a professional networking application may be presented using a textual scheme to provide a name 516, and graphical schemes, such as a comment icon 520 to indicate the type of feedback and a professional icon 518 to represent the professional networking application associated with “User 3”. In some embodiments, one or more of the users invited to provide feedback may be enabled to view comments made by other users and then comment on and/or like the previous comments themselves, as illustrated by an icon representing multiple comments 522 provided by “User 3” and “User 4”.

As shown in FIG. 5B, diagram 500B, in response to the first user hovering over a like and/or comment provided by a second user, such as the comment 514 provided by “User 3”, through a user action 526, the word-processing application 502 may be configured to display further information 528 associated with the second user. The information 528 may include, among other things, a networking application 530 associated with the second user, a name 532, a photograph 534, and a location 536 of the second user. The information 528 may further include a job title 538, a company 540, and an experience 542 associated with the second user. The information 528 may be provided by the networking application associated with the second user, for example.

In some examples, the information 528 provided may enable the first user to determine how much collaborative influence the second user should possess and thus, if the feedback should impact an editing of the content 504. For example, if the content 504 is a document describing environmentally friendly building structures, feedback provided from an environmental engineer that has had over 20 years of experience (as provided by the information 528) may be given more weight than feedback provided from an engineering student at a local university.

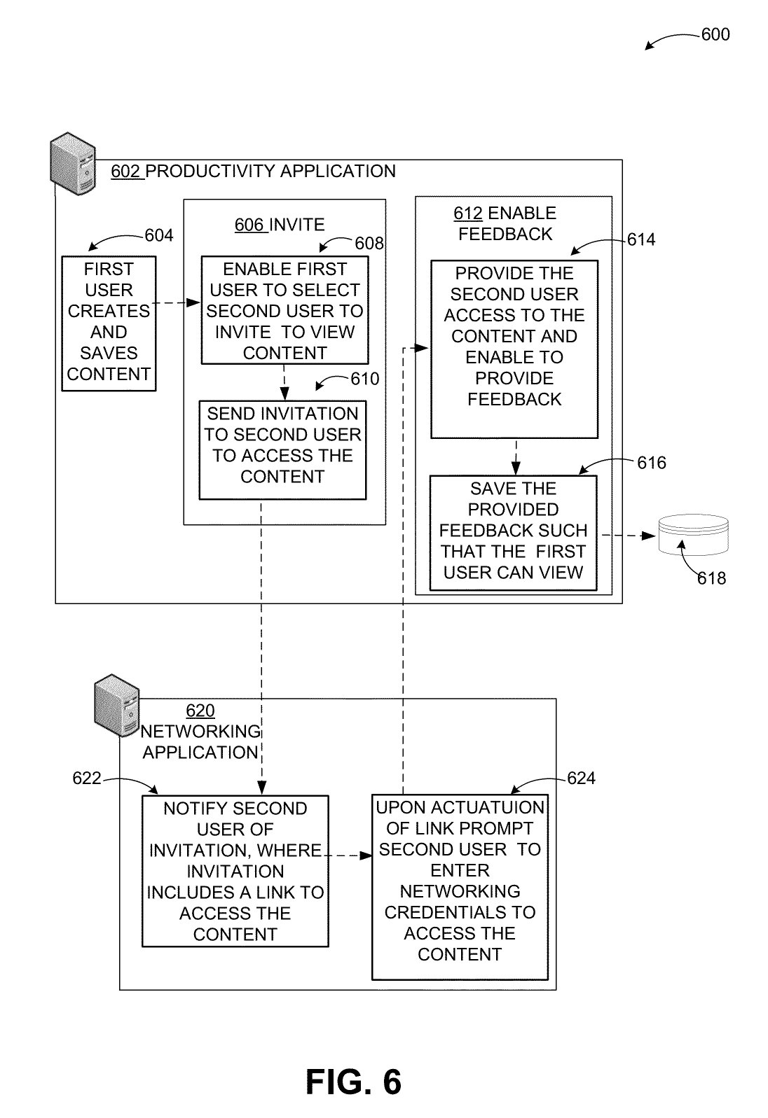

FIG. 6 illustrates an example system configured to enable document collaboration through networking credentials. As shown in a diagram 600, a productivity application 602 may enable a first user to create and save content 604. The first user may invite 606 a second user to view the content, where a control element provided through a user experience of the productivity application 602 may enable the first user to select the second user to invite to view the content 608. An invitation may then be sent to the second user 610 to access the content. The invitation may be sent to a networking application 620 associated with the second user, for example.

The networking application 620 may be configured to notify the second user of the invitation 622 through a graphical and/or textual scheme displayed through a user experience of the networking application 620. In some examples, the invitation may include a link to a location of the content. When the link is actuated by the second user, the networking application 620 may prompt the second user to log in to the productivity application 602 by entering networking application credentials associated with the second user to access the content 624.

The productivity application 602 may be configured to enable the second user to provide feedback 612 by providing one or more other control elements through the user experience of the productivity application 602 that enable the second user to provide feedback in conjunction with the content once the content is accessed 614. The feedback may include comments and/or likes based on feedback permissions associated with the second user. In some examples, the second user may also be enabled to view comments left by one or more other users based on the feedback permissions. The feedback permissions associated with the second user may be assigned through the networking application credentials, and may be based on the networking application 620 or the second user. For example, only users associated with professional networking applications may be enabled to provide comments. The feedback may then be saved 616 in conjunction with the content such that the first user may be enabled to view the feedback. The feedback may be saved to a data store 618 associated with the productivity application. The data store 618 may be a part of a computing device or may be a cloud data store, for example.

The examples in FIGS. 1 through 6 have been described using specific network environments, systems, applications and user experiences to enable document collaboration through networking credentials. Embodiments to enable document collaboration through networking credentials are not limited to the specific network environments, systems, applications and user experiences according to these examples.

Document collaboration through networking credentials, as described in the embodiments herein, may enable users to access content of a productivity application through networking application credentials associated with the users. Enabling access to the content through the networking credentials may advantageously increase user efficiency and improve usability, which may further promote collaboration among multiple users. For example, if a first user is seeking feedback on a document from his/her colleagues at work and friends outside work, instead of having to individually send each colleague/friend the documents through multiple different communication modes, the first user may easily invite the colleagues/friends through a control element provided by the productivity application. Contextual determination of the content may improve usability by presenting the first user a list of likely potential colleagues/friends to select from to invite. Furthermore, by enabling the colleagues/friends access to the document within the productivity application through their networking application credentials, feedback may be saved in conjunction with the document within the productivity application such that the user may view the feedback through the productivity application. This may save time and frustration when multiple colleagues and friends are providing feedback as the first user doesn't have to combine feedback from multiple versions of the document.

The presentation of the feedback to the first user may also improve usability. For example, by distinctly presenting each comment and like based on one or both of a colleague/friend who provided the comment and like, and the networking application associated with the colleague/friend, the first user may quickly distinguish the comments and likes. The first user may also be enabled to quickly review information, such as a job title and experience, associated with each colleague/friend by hovering over the associated comment and like, enabling the first user to determine how much influence the comment and like should have based on the information.

Additionally, by requiring network credentials to login to the productivity application, process security may be increased, which may be beneficial if the content is confidential. The assignment of feedback permissions may also enhance a reliability of the process, such that only users with collaborative privileges may have full permissions.

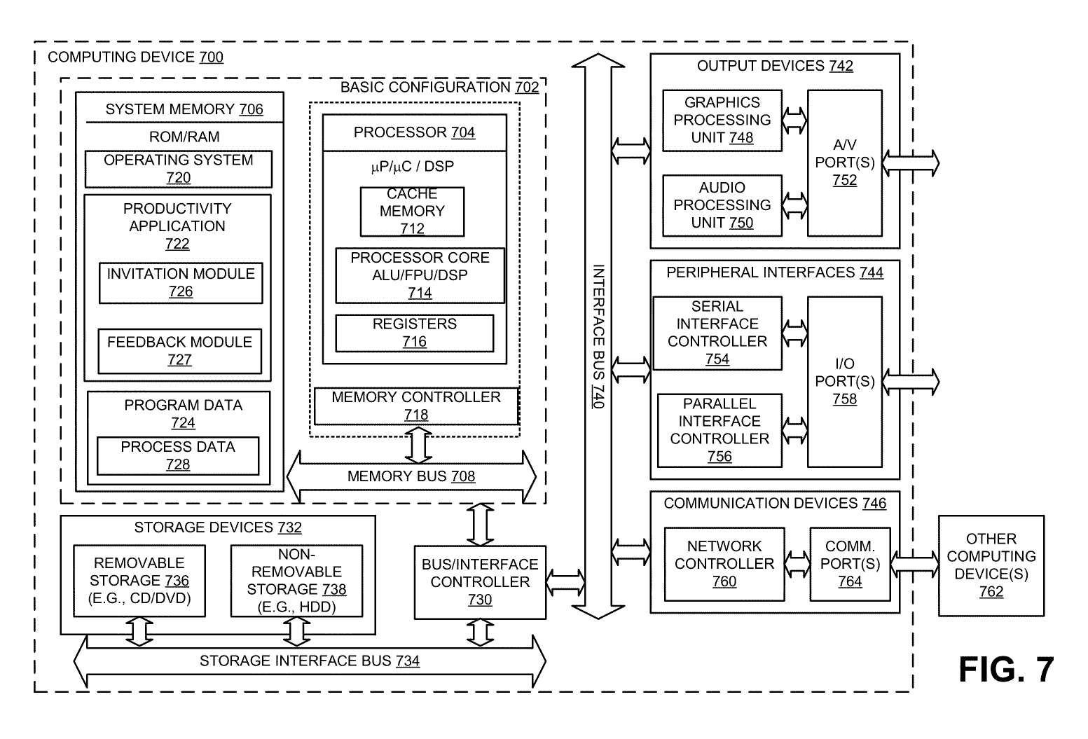

FIG. 7 and the associated discussion are intended to provide a brief, general description of a general purpose computing device, which may be used to enable document collaboration through networking credentials.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, a productivity application 722, and program data 724. The productivity application 722 may include an invitation module 726 and a feedback module 727, which may be integrated modules of the productivity application 722 or separate applications. The invitation module 726 may be configured to provide a control element through a user experience of the productivity application 722 to enable a first user to select a second user to invite to view content of the productivity application 722. The invitation module 726 may send an invitation to the second user to access the content, where the second user may be enabled to access the content within the productivity application by providing networking application credentials associated with the second user. The feedback module 727 may then be configured to provide one or more other control elements through the user experience of the productivity application 722 to enable the second user to provide feedback on the content within the productivity application. The program data 724 may include, among other data, process data 728 related to the feedback and content, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to enable document collaboration through networking credentials. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be, automated such as by pre-selected criteria that may be machine automated.

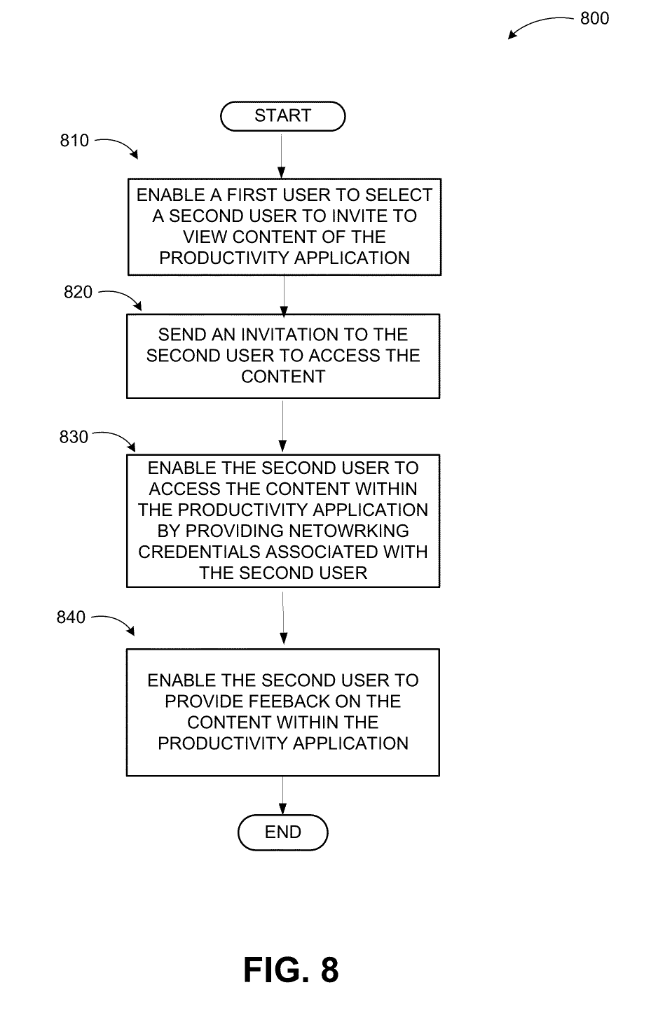

FIG. 8 illustrates a logic flow diagram for process 800 of a method to enable document collaboration through networking credentials, according to embodiments. Process 800 may be implemented, on a server or other system.

Process 800 begins with operation 810, where a control element may be provided through a user experience of a productivity application to enable a first user to select a second user to invite to view content of the productivity application. In some embodiments, a list of potential users for selection may be provided to the first user through the user experience upon actuation of the control element such that the first user is enabled to select the second user efficiently. The provided list may be based on determined context of the content. For example, one or more unlikely users to invite may be removed based on the determined context, and the remaining users to invite may be prioritized based on the determined context and presented in the list. In other embodiments, the first user may be enabled to select the second user from a list of users provided through a user experience of a networking application associated with the first user upon actuation of the control element.

At operation 820, an invitation may be sent to the second user to access the content. The invitation may be sent to the second user through a networking application associated with the second user. Upon receipt of the invitation, the networking application may be configured to notify the second user of the invitation. In some examples, the invitation may include a link to a location of the content. Upon actuation of the link by the second user, the networking application, may prompt the second user to login to the productivity application using networking application credentials associated with the second user.

At operation 830, the second user may be enabled to access the content within the productivity application by providing the networking application credentials associated with the second user. At operation 840, one or more other controls may be provided through the user experience of the productivity application that enable the second user to provide feedback on the content within the productivity application. The feedback may include comments and/or likes. In some embodiments, feedback permissions may be assigned through the networking application credentials associated with the second user, where the feedback permissions may be based on one or both of the second user and the networking application. The feedback may be saved in conjunction with the content of the productivity application such that the first user may be enabled to view the feedback, which may be presented to the first user through the user experience of the productivity application.

The operations included in process 800 are for illustration purposes. Document collaboration through networking credentials may be implemented by similar processes with fewer or additional steps, as well as in different order of operations using the principles described herein.

A means for enabling document collaboration through networking credentials may include a means for providing a control element through a user experience of a productivity application to enable a first user to select a second user to invite to view content of the productivity application, a means for sending an invitation to the second user to access the content, a means for enabling the second user to access the content within the productivity application by providing networking application credentials associated with the second user, and a means for providing one or more other control elements through the user experience of the productivity application to enable the second user to provide feedback on the content within the productivity application.

According to some examples, methods to enable document collaboration through networking credentials are provided. An example method may include providing a control element through a user experience of a productivity application to enable a first user to select a second user to invite to view content of the productivity application, and sending an invitation to the second user to access the content. The example method may also include enabling the second user to access the content within the productivity application by providing networking application credentials associated with the second user, and providing one or more other control elements through the user experience of the productivity application to enable the second user to provide feedback on the content within the productivity application.

In other examples, the feedback provided by the second user may be saved within the content such that the first user is enabled to view the feedback. The feedback provided by the second user may be presented to the first user through the user experience of the productivity application. At least one of a textual scheme, a graphical scheme, an audio scheme, an animation scheme, a coloring scheme, a highlighting scheme, and/or a shading scheme may be employed to enhance presentation of the feedback though the user experience of the productivity application. In response to the first user hovering over the presented feedback, information associated with the second user may be displayed through the user experience of the productivity application. The information may be collected from the networking application.

In further examples, feedback from multiple users may be presented from multiple networking applications simultaneously to the first user through the user experience of the productivity application. The feedback from each user may be presented distinctly. The feedback from each networking application may be presented distinctly. Feedback permissions may be assigned to the second user through the networking application credentials associated with the second user, where the feedback permissions may be based on the networking application and/or the second user. Enabling the first user to select the second user to invite to view the content of the productivity application may further include determining a context of the content, removing one or more unlikely users to invite based on the determined context, prioritizing remaining users to invite based on the determined context, and presenting the first user a list of potential users for selection such that the first user is enabled to select the second user efficiently.

According to some embodiments, computing devices configured to enable document collaboration through networking credentials are described. An example computing device may include a memory configured to store one or more instructions, and a processor coupled to the memory, where the processor may be configured to execute a productivity application. The productivity application may be configured to provide a control element through a user experience of the productivity application to enable a first user to select a second user to invite to view content of the productivity application, and send an invitation to the second user to access the content, where the invitation includes a link to a location of the content. The productivity application may be further configured enable the second user to access the content within the productivity application through provision of networking application credentials associated with the second user in response to the second user actuating the link, and provide one or more other control elements through the user experience of the productivity application to enable the second user to provide feedback on the content within the productivity application.

In other embodiments, the content may include structured data and/or streaming data associated with audio, video, graphics, images, and text. The feedback may include comments and/or likes. The second user may be enabled to view feedback provided by one or more other users based on one or more feedback permissions assigned to the second user.

According to some examples, systems configured to enable document collaboration through networking credentials are described. An example system may include a first server configured to manage content of a productivity application, and a second server configured to provide access to the productivity application to a plurality of users. The productivity application may be configured to provide a control element through a user experience of the productivity application to enable a first user to select a second user to invite to view content of the productivity application, and send an invitation to the second user to access the content, wherein the invitation includes a link to a location of the content. The productivity application may further be configured enable the second user to access the content within the productivity application by providing networking application credentials associated with the second user in response to the second user actuating the link, and provide one or more other control elements through the user experience of the productivity application to enable the second user to provide feedback on the content within the productivity application. The example computing device may also include a data store configured to save the feedback provided by the second user such that the first user is enabled to view the feedback.

In other examples, the invitation may be sent to a networking application associated with the second user. The networking application may be a social networking application or a professional networking application. The productivity application may be provided by a third party service or a web application.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to enable document collaboration through networking credentials, the method comprising:
providing a control element through a user experience of a productivity application to enable a first user to select a second user to invite to view content of the productivity application;
sending an invitation to the second user to access the content;
enabling the second user to access the content within the productivity application by providing networking application credentials associated with the second user; and
providing one or more other control elements through the user experience of the productivity application to enable the second user to provide feedback on the content within the productivity application.

2. The method of claim 1, saving the feedback provided by the second user within the content such that the first user is enabled to view the feedback.

3. The method of claim 1, further comprising:
presenting the feedback provided by the second user to the first user through the user experience of the productivity application.

4. The method of claim 3, further comprising:
employing at least one from a set of: a textual scheme, a graphical scheme, an audio scheme, an animation scheme, a coloring scheme, a highlighting scheme, and a shading scheme to enhance presentation of the feedback though the user experience of the productivity application.

5. The method of claim 3, further comprising:
in response to the first user hovering over the presented feedback, displaying information associated with the second user through the user experience of the productivity application.

6. The method of claim 5, wherein the information is collected from the networking application.

7. The method of claim 1, further comprising:
presenting feedback from multiple users from multiple networking applications simultaneously to the first user through the user experience of the productivity application.

8. The method of claim 7, further comprising:
presenting the feedback from each user distinctly.

9. The method of claim 7, further comprising:
presenting the feedback from each networking application distinctly.

10. The method of claim 1, further comprising:
assigning feedback permissions to the second user through the networking application credentials associated with the second user.

11. The method of claim 10, wherein the feedback permissions are based on one or more of the networking application and the second user.

12. The method of claim 1, wherein enabling the first user to select the second user to invite to view the content of the productivity application further comprises:
determining a context of the content;
removing one or more unlikely users to invite based on the determined context;
prioritizing remaining users to invite based on the determined context; and
presenting the first user a list of potential users for selection such that the first user is enabled to select the second user efficiently.

13. A computing device configured to enable document collaboration through networking credentials, the computing device comprising:
a memory configured to store one or more instructions;
a processor coupled to the memory, the processor configured to execute a productivity application, where the productivity application is configured to:
provide a control element through a user experience of the productivity application to enable a first user to select a second user to invite to view content of the productivity application;
send an invitation to the second user to access the content, wherein the invitation includes a link to a location of the content;
enable the second user to access the content within the productivity application through provision of networking application credentials associated with the second user in response to the second user actuating the link; and
provide one or more other control elements through the user experience of the productivity application to enable the second user to provide feedback on the content within the productivity application.

14. The computing device of claim 13, wherein the content includes one or more of structured data and streaming data associated with audio, video, graphics, images, and text.

15. The computing device of claim 13, wherein the feedback comprises one or more of comments and likes.

16. The computing device of claim 13, wherein the second user is enabled to view feedback provided by one or more other users based on one or more feedback permissions assigned to the second user.

17. A system configured to enable document collaboration through networking credentials, the system comprising:
a first server configured to manage content of a productivity application; and
a second server configured to provide access to the productivity application to a plurality of users, wherein the productivity application is configured to:
provide a control element through a user experience of the productivity application to enable a first user to select a second user to invite to view content of the productivity application;
send an invitation to the second user to access the content, wherein the invitation includes a link to a location of the content;
enable the second user to access the content within the productivity application by providing networking application credentials associated with the second user in response to the second user actuating the link; and
provide one or more other control elements through the user experience of the productivity application to enable the second user to provide feedback on the content within the productivity application; and
a data store configured to save the feedback provided by the second user such that the first user is enabled to view the feedback.

18. The system of claim 17, wherein the invitation is sent to a networking application associated with the second user.

19. The system of claim 18, wherein the networking application is one of a social networking application and a professional networking application.

20. The system of claim 17, wherein the productivity application is one of provided by a third party service and a web application.
